(19) United States
(12) Patent Application Publication
(10) Pub. No.: US 2017/0202251 A1
(43) Pub. Date: Jul. 20, 2017

(54) WHEY PROTEIN AGGREGATES

(71) Applicant: NESTC S.A., Vevey (CH)

(72) Inventors: Michael John Callanan, Lausamme (CH); Christophe Joseph Etienne Schmitt, Servion (CH); Martin Michel, Lausamme (CH); Malte Pas, Bern (CH); Lurnce Donato-Capel, Cheseaux sur Lausanne (CH)

(73) Assignee: NESTEC S.A., Vevey (CH)

(21) Appl. No.: 15/327,799

(22) PCT Filed: Jul. 8, 2015
(86) PCT No.: PCT/EP2015/065564

§ 371 Date: Jan. 20, 2017

(30) Foreign Application Priority Data
Jul. 24, 2014 (EP) 14178265.6

(51) Int. Cl. A23L 2/66; A23L 33/19; A23J 3/08

(52) U.S. Cl. CPC A23L 2/66; A23J 3/08; A23L 33/19; A23V 2002/00

(57) ABSTRACT

The present invention relates to whey protein aggregates, in particular to a process for forming whey protein aggregates. The present invention also pertains to compositions comprising whey protein aggregates obtainable by the process and the use of these compositions as a foaming agent or emulsifier.

### FIELD OF THE INVENTION

The present invention relates to whey protein aggregates, in particular to a process for forming whey protein aggregates. The present invention also pertains to compositions comprising whey protein aggregates obtainable by the process and the use of these compositions as a foaming agent or emulsifier.

### BACKGROUND OF THE INVENTION

Whey protein is a complete protein containing all of the essential amino acids (“building blocks”) your body needs and is one of the best sources of branched-chain amino acids such as leucine, which has been shown to stimulate muscle synthesis.

Whey protein is also easy to digest and has been linked to increased satiety. For these reasons whey protein is considered a good protein source to include in consumable products such as high protein sports drinks and meal replacement beverages. Such products are commonly consumed by athletes, the elderly, or post-operative patients.

One drawback of whey protein is its heat sensitivity. At high temperatures, e.g. those encountered during heat sterilization, whey protein denatures and can form insoluble protein aggregates and gels. This denaturation particularly occurs when the whey protein is present at high concentrations (over 3 wt. %) and in neutral or slightly acidic pH environments. In liquid products this leads to excessive turbidity, increased viscosity, phase separation and/or precipitation. This behaviour can limit the amount of whey protein which can be incorporated in consumable products, especially those which need to be sterilized, for example products for the elderly or sick.

Accordingly, it is often necessary to restrict or minimise the concentration of whey protein in consumable products, in particular in beverages, so as to ensure their quality. This can result in consumers needing to consume high volumes in order to cover daily protein requirements.

In an effort to avoid or mitigate the problems described above, alternative sterilization technologies which are milder to heat sensitive consumer product ingredients, such as whey protein, are sometimes employed e.g. hydrostatic high pressure processing, irradiation and pulsed electrical field. However, a serious drawback of these technologies is that they are usually higher in cost then thermal sterilization. They may also not adequately ensure microbiological safety.

Because of the problems highlighted above, non-precipitating whey protein aggregates have been developed. These whey protein aggregates exhibit colloidal stability in liquids at high concentrations and are heat stable i.e. do not precipitate when undergoing thermal treatment such as pasteurization. Accordingly, these aggregates can be added to consumable products without the risk that they will impact the quality of said consumable products upon thermal treatment e.g. pasteurisation. EP1839492 describes a process for the production of whey protein micelles which involves reducing the pH of a whey protein isolate dispersion to an optimum micellisation pH by adding hydrochloric acid and then heating to form protein aggregates which are heat stable and do not spontaneously precipitate. However, the use on an industrial scale of concentrated acid presents safety and environmental drawbacks. Also, the whey protein aggregates formed in this way require a separate processing step in order to be made sterile.

Accordingly, there remains a need for a method of forming whey protein aggregates that avoids or mitigates one or more of the drawbacks highlighted above. An object of the present invention is to improve the state of the art and to provide a solution to overcome at least some of the inconveniences described above or at least to provide a useful alternative.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The object of the present invention is achieved by the subject matter of the independent claims. The dependent claims further develop the idea of the present invention.

### SUMMARY OF THE INVENTION

Surprisingly, the inventors have now found that whey protein aggregates can be formed by heating a native whey protein solution so as to denature the whey protein, and dissolving carbon dioxide in the solution under pressure. Forming the whey protein aggregates in this way allows for the generation of a wide variety of aggregate sizes and size distributions by altering the conditions such as pressure, time and whey protein concentration. The aggregrates can have different functionality (solubility, emulsification) depending on size and distribution generated by the selected processing conditions. Duoxia Xu et al. [Duoxia Xu et al., Innovative Food Science and Emerging Technologies, 12, 32-37 (2011)] found that the structure and conformation of native whey proteins could be altered by supercritical carbon dioxide treatment, but they did not investigate applying the supercritical carbon dioxide treatment to whey proteins which had been denatured by heat. Accordingly, Duoxia Xu et al. did not form whey protein aggregates with the same size, size distribution or functionality of the aggregrates described here.

The present invention provides in a first aspect a process for forming a whey protein aggregates, the process comprising heating a native whey protein solution with optional further components at a temperature above 80° C.; dissolving carbon dioxide in the whey protein solution at a pressure greater than 7.39 MPa absolute, and; releasing the pressure to a level below 0.2 MPa absolute.

In a second aspect, the invention relates to a composition comprising whey protein aggregates obtainable by the process of the invention. In a further aspect, the invention relates to the use of the composition comprising whey protein aggregates as a foaming agent or emulsifier.

### BRIEF DESCRIPTION OF THE DRAWINGS

FIG. 1 shows a schematic representation of a process for forming powdered whey protein aggregates

FIG. 2 shows SEM micrographs of whey protein aggregate dispersions produced according to the process of the invention FIG. 3 shows a SEM micrograph of the comparative sample of example 6: pH=5.2, no CO₂, other conditions as VCT011312.

FIG. 4 shows the particle size distribution by volume of trial VCT011312 measured with Mastersizer 2000 FIG. 5 shows the particle size distribution by volume of the comparative sample of example 6: pH=5.2, no CO₂, other conditions as VCT011312, measured with Mastersizer 2000 FIG. 6 shows interfacial tension (mN/m) between air and whey protein aggregate solution (concentration 0.004%) against time (s) for samples VCT021312 and VCT011312. The reference is 0.001% ethanol solution.

FIG. 7 shows interfacial tension (mN/m) between air and whey protein aggregate solution (concentration 0.04%) against time (s) for samples VCT021312 and VCT011312. The reference is 0.01% ethanol solution.

FIG. 8 shows interfacial tension (mN/m) between oil and whey protein aggregate solution (concentration 0.004%) against time (s) for samples VCT021312 and VCT011312. The reference is water/oil.

FIG. 9 shows interfacial tension (mN/m) between oil and whey protein aggregate solution (concentration 0.04%) against time (s) for samples VCT021312 and VCT011312. The reference is water/oil.

### DETAILED DESCRIPTION OF THE INVENTION

The present invention relates in part to a process for forming whey protein aggregates, the process comprising heating a native whey protein aqueous solution with optional further components at a temperature above 80° C.; dissolving carbon dioxide in the whey protein solution at a pressure greater than 7.39 MPa absolute, for example between 7.39 and 70 MPa absolute, for further example between 30 MPa and 70 MPa absolute, and; releasing the pressure to a level below 0.2 MPa absolute. The process of the invention may be operated as a continuous process. Whey protein aggregates are denatured whey proteins which have interacted to form larger structures. The whey protein aggregates formed by the process of the invention may be limited in size, for example the whey protein aggregates may have a z-average hydrodynamic diameter less than 5.0 μm, for example less than 4.0 μm, for example less than 2.0 μm. Smaller whey protein aggregates are more stable in suspensions. The z-average hydrodynamic diameter may for example be measured using a Malvern Nanosizer ZS. The size distribution of the whey protein aggregates may be such that their median size is small. The whey protein aggregates formed by the process of the invention may have a D[v,50] of less than 1.5 μm, for example less than 1.0 μm. D[v,50] being the volume percentage particle size which divides the population exactly into two equal halves, calculated according to ISO 9276-2:2001. The D[v,50] may for example be measured using a Malvern Mastersizer 2000.

The native whey protein is heated to a temperature which induces denaturation of the protein, this may for example be above 80° C., for example between 80° C. and 100° C., for further example between 82° C. and 90° C. Mixing may be applied during the dissolution of the carbon dioxide in the whey protein solution. Under the temperature conditions of the process, the carbon dioxide will be in its supercritical state at pressures above 7.39 MPa absolute. The release of pressure may be rapid, for example the pressure may be reduced from greater than 7.39 MPa to below 0.2 MPa within 1 s. As the pressure is released the carbon dioxide will form a gas which may be collected and recycled. The process may further comprise concentrating or drying the whey protein aggregates. The whey protein aggregates may be dried by any known techniques, such as spray-drying, freeze-drying, roller drying etc. The whey protein aggregates may be spray-dried with or without addition of further ingredients and may be used as a delivery system or a building block to be used in a wide range of processes.

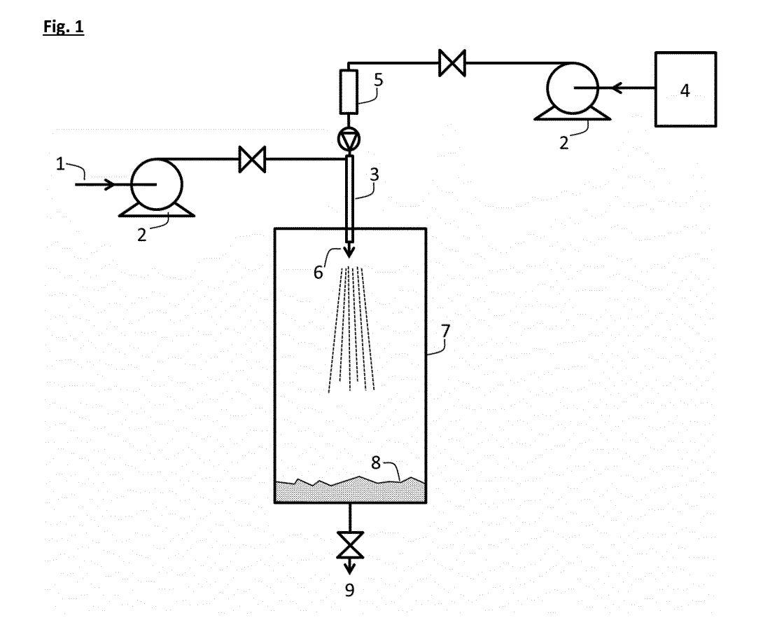

In the process of the invention, the pressure may be released by passing the whey protein solution with dissolved carbon dioxide through a nozzle and evaporating water, for example using a heated nozzle, so as to form a powder comprising whey 3.0 protein aggregates. If any optional further components are volatile, for example ethanol, then they will be evaporated together with the water. An example of such a process is shown in FIG. 1. A solution of native whey protein (4) and any optional further components is fed by a pump to a heating device (5) and then passed via a non-return valve into a static mixer. Carbon dioxide (1) is fed by a separate pump (2) to the static mixer (3), maintaining an elevated pressure in the mixer. Whey protein aggregates are formed in the mixer. At the exit of the static mixer is a heated nozzle (6) which feeds into a particle collection vessel (7). As the liquid containing whey protein aggregates leaves the nozzle the pressure is released, and particles of powder are formed in a manner analogous to spray drying. The powdered whey protein aggregates (8) are collected and the carbon dioxide removed for re-use (9).

An optional further component in the heated aqueous solution according to the process of the invention may be ethanol at a level of between 5 and 20 wt. % in the solution. Ethanol reduces interfacial tension between water and any carbon dioxide which has not dissolved in the solution. The inventors found that the addition of ethanol altered the size of the aggregates produced, generally resulting in a narrower size distribution. The native whey protein may be present in solution at a concentration of between 0.5 wt. % and 40 wt. %, for example between 1 wt. % and 25 wt. %, for further example between 2 wt. % and 16 wt. %. The higher the concentration of native whey protein going into the process, the higher the concentration of whey protein aggregates that will be formed by the process. When the whey protein aggregates are to be used without drying to a powder it is beneficial that the invention may provide a high concentration of whey protein aggregates. However, when the whey protein aggregates are to be dried by a method such as spray drying it may be preferable to have a lower concentration of whey protein aggregates so as to have an appropriate viscosity for the drying process.

The volume ratio of native whey protein solution to carbon dioxide may be between 1:99 and 99:1 in the process of the invention under the operating conditions. For example the volume ratio of native whey protein solution to carbon dioxide may be between 40:60 and 98:2, for further example between 50:50 and 95:5.

Once the native whey protein has been denatured by heating, the conversion to whey protein aggregates by the action of the dissolved carbon dioxide under pressure should, in principle, be rapid. In practice it may take time for the carbon dioxide to contact all the whey protein, and this will depend to some extent on the stirring system used. The inventors found that at longer treatment times larger aggregates were formed and so by maintaining the whey protein solution with dissolved carbon dioxide at pressures greater than 7.39 MPa for different lengths of time the aggregate size could be controlled. The whey protein solution with dissolved carbon dioxide may be maintained at a pressure greater than 7.39 MPa for at least 1 minute in the process of the invention, for example between 2 and 30 minutes, for further example between 5 and 20 minutes. The process of the invention may comprise heating a native whey protein solution with optional further components at a temperature between 80° C. and 95° C.; dissolving carbon dioxide in the whey protein solution at a pressure between 30 and 70 MPa absolute and maintaining this pressure for between 2 and 20 minutes, and; releasing the pressure to a level below 0.2 MPa absolute; wherein the native whey protein is present in solution at a concentration of between 10 wt. % and 20 wt. %.

The native whey protein solution with optional further components in the process of the invention may have an initial pH between 6.2 and 9.0. The initial pH is the pH before carbon dioxide is dissolved in the whey protein solution. Maintaining the pH above 6.2 prevents or limits the formation of aggregates before the application of carbon dioxide, such aggregates might lead to fouling of the feed systems and may not have the desirable characteristics of whey protein aggregates formed by the process of the invention. The native whey protein solution in the process of the invention may have an initial pH between 6.3 and 8.5, for example between 6.4 and 8.0.

The native whey protein in the process of the invention may be in the form of whey protein isolate or whey protein concentrate. The native whey protein may be whey obtained by milk microfiltration. The native whey protein may be from a single source or from mixtures of any sources. The native whey protein in the process of the invention may contain less than 2.5 wt. % divalent cations. High mineral content in whey protein aggregates may lead to off-tastes, also the presence of minerals in the whey protein may alter the nature of aggregates formed by condensing them due to excessive charge neutralisation. The native whey protein in the process of the invention may contain less than less than 2 wt. %, for example less than 0.2 wt. %. The native whey protein may be completely demineralised.

An advantage of using carbon dioxide in the process under conditions where it is in its supercritical state is that the supercritical carbon dioxide is able to deactivate bacteria. This provides a sterile liquid product, or one in which the bacterial load has been reduced. This is beneficial when the whey protein aggregates are used in products to be consumed by vulnerable persons such as those in hospital or the elderly. To further enhance this effect, and to permit total deactivation of bacteria including heat resistant spores, bacteria inactivation agents may be added. The whey protein solution with dissolved carbon dioxide in the process of the invention may further comprise bacteria inactivation agents such as propionic acid, lactic acid, hydrogen peroxide, tert-butyl hydroperoxide or peracetic acid. For example, the whey protein solution with dissolved carbon dioxide in the process of the invention may further comprise up to 1 wt. % of a bacteria inactivation agent selected from the group consisting of hydrogen peroxide, tert-butyl hydroperoxide and peracetic acid.

In a further aspect, the invention provides a composition comprising whey protein aggregates obtainable by the process of the invention. The whey protein aggregates obtainable by the process of the invention have a unique structure and size distribution. This provides improved properties such as emulsion stabilization. Adjusting the pH to the isoelectric point without applying supercritical CO₂ was found to form much larger aggregates, forming chains rather than the sponge-like structures of the whey protein aggregates obtainable by the process of the invention. The aggregates formed by the process of the invention were also different from those formed in EP1839492, which combined a size of between 200-400 nm with a very narrow polydispersity index of less than 0.200.

The composition comprising the whey protein aggregates obtainable by the process of the invention may be a food composition, cosmetic composition or pharmaceutical composition. The whey protein aggregates may be mixed with 5% of an acidic fruit base and 5% of sucrose in order to obtain a stable whey protein enriched acidic fruit drink. The process of the invention may provide aqueous liquids with high levels of whey protein which are stable against spontaneous precipitation. The composition comprising the whey protein aggregates obtainable by the process of the invention may be a concentrated whey protein drink.

Solutions of whey protein aggregates formed by the process of the invention were found to reduce interfacial tension between air and the solution, showing that they can stabilize foams. Solutions of whey protein aggregates formed by the process of the invention were also found to reduce interfacial tension between oil and the solution. This demonstrates their suitability for use as emulsifiers. The composition comprising whey protein aggregates obtainable by the process of the invention may be used as a foaming agent or emulsifier. The whey protein aggregates may act as a fat substitute while maintaining desirable structural, textural and organoleptic properties.

The whey protein aggregates obtained according to the method of the present invention can be used for the preparation of any kind of food product requiring stabilization of an emulsion or a foam, such as a mousse or ice cream, a coffee creamer, or a low fat or essentially fat free dairy product. The food product may be in any form, including beverages, soups, semi-solid foods etc. which can be consumed by a human or an animal. Examples for products where the whey protein aggregates may find application are for example, dairy products, mayonnaise, salad dressing, pasteurized UHT milk, sweet condensed milk, yoghurt, fermented milks, sauces, reduced fat sauces such as béchamel sauce for instance, milk-based fermented products, milk chocolate, white chocolate, dark chocolate, mousses, foams, emulsions, ice creams, fermented cereal based products, milk based powders, infant formula, diet fortifications, pet food, tablets, liquid bacterial suspensions, dried oral supplement, wet oral supplement, performance nutrition bars, spreads, fruit drinks and coffee mixes. The composition comprising whey protein aggregates obtainable by the process of the invention may be a nutritional composition, dairy product, ice cream, sauce, pet food or confectionery product.

Those skilled in the art will understand that they can freely combine all features of the present invention disclosed herein. In particular, features described for the process of the present invention may be combined with the product of the present invention and vice versa. Further, features described for different embodiments of the present invention may be combined. Where known equivalents exist to specific features, such equivalents are incorporated as if specifically referred to in this specification. Further advantages and features of the present invention are apparent from the figures and non-limiting examples.

### Examples

### Example 1: Production of Whey Protein Aggregates—Pressure Temperature and Stirrer Speed Constant

Whey protein isolate (WPI) Prolacta 90 was purchased from Lactalis ingredients (Rétiers, France). Carbon dioxide was purchased from Carbagas (Domdidier, Switzerland) with 99.5% purity. Aqueous WPI solutions were prepared by dissolving WPI powder (4, 7 and 10 wt. %) in MilliQ water. pH adjustment was done either with 1M hydrochloric acid (Merck, Switzerland) or 1M sodium hydroxide (Merck, Switzerland). As modifier technical grade ethanol 100% (Merck, Switzerland) was used.

Experimental Set-Up

A high pressure view cell was supplied by NWA (Lorrach, Germany). The volume of the cell can be changed with a lockable piston from 32-63 ml. It is designed for maximum operating pressure and temperature of 70 MPa at 250° C., respectively. For observing the samples, the cell is equipped with one sapphire window and a light source in the back. Approximately 30 g WPI solution were loaded with a syringe into the pre-heated view cell, sealed and pressurised with a pneumatic pump (Pickel PM 101, NWA, Lorrach) injecting carbo dioxide (CO₂) until the final pressure is reached. The inlet valve was locked when the designated pressure was reached and agitation as achieved by a three paddle stirrer (vmax.=3000 rpm). After treatment, the vessel was rapidly depressurized. CO₂ and sample were completely removed from the extractor by opening the outlet valve and the sample was collected in a 250 ml silicon bottle.

pH Measurement

The pH of the whey protein dispersions was measured immediately after treatment using an 826 mobile pH meter (Metrohm, Switzerland).

Determination of Protein Composition

To determine the protein composition after treatment, samples were diluted with MilliQ water to a protein content of 0.1% w/w. The diluted samples were centrifuged for 30 minutes at 14.000 g, using a Heraeus Pico 21 (Thermo Fischer Scientific, Switzerland, rotor 75003410) and the supernatant 1 (SN1) was collected. SN1 will contain residual native protein and soluble aggregates while the pellet will contain the insoluble protein. A second set of treated samples were then diluted with acetic/sodium buffer (0.5M, pH 4.6) and MilliQ water to a whey protein concentration of 0.1% w/w. After centrifugation for 15 minutes at 14.000 G, supernatant 2 (SN2) was collected. The supernatant SN2 will contain residual native protein and the pellet will contain any protein aggregates.

Measuring the absorbance at a wavelength of 280 nm using a Varioskan Flash spectrometer (Thermo Fischer Scientific, Switzerland) of native whey protein dispersion and supernatants (SN1 and SN2) allowed the percentage of residual native, insoluble and soluble protein aggregates to be calculated [L. Donato et al., International Dairy Journal, 19, 295-306 (2009)].

Determination of Hydrodynamic Diameter of Protein Aggregates

After treatment, particle size of WPI aggregate dispersions was characterised using a Nanosizer ZS apparatus (Malvern Instruments Ltd., USA) equipped with a 5 mW laser at 622 nm, operating at a detection angle of 173°. Treated samples were diluted 1/100 in MilliQ water to prevent multiple scattering of light. From the variation of the scattered intensity with time, an autocorrelation function was calculated and fitted according to the method of the “cumulants” to extract the z-average hydrodynamic diameter of protein particles. Moreover polydispersity index (PDI) is determined by Nanosizer, indicating the width of the size distribution of the aggregates when PDI 0.2.

### Experimental Plan

A high number of variables were involved in the experimental set-up (pressure p, temperature t, time T, volume ratio whey protein solution:CO₂, initial pH, initial WPI concentration %, stirrer speed vₛₜ). Accordingly, a statistically designed experiment was performed (DoE). In the first planned DoE the following parameters were kept constant: maximum pressure of equipment (p=60 MPa) and temperature (T=85° C.) were applied to induce maximum denaturation of the native WPI protein. Maximum stirrer speed (vₛₜ=3.000 rpm) was employed to ensure a rapid dissolution of CO₂ in WPI solution to have a constant distributed pH. The pH of untreated solution was kept at its initial value of about 6.45. A 4 wt. % WPI solution was treated. The following parameters were varied because they were expected to have the largest impact on pH during treatment and trial plan was a full factorial design of 3 parameters with 3 levels each:

| | |
|---|---|
| Volume ratio WPI/CO₂ | 3 levels: 50:50, 72.5:27.5, 95:5 |
| WPI concentration [wt. %] | 3 levels: 4, 7, 10 |
| Time [min] | 3 levels: 5, 12, 20 |

Table 1 describes the trends from the first DoE.

| | | | | Impact on amount |
|---|---|---|---|---|
| | | | Impact on | of insoluble |
| Parameters | | Impact on size | PDI | WP aggregates |
| Treatment time [min] | 5, 12 and | Longer treatment | No impact | Longer time increases |
| | 20 | increases particle size | | insoluble aggregates |
| WPI concentration [%] | 4, 7 and | Smaller particles at 7% | No impact | No impact |
| | 10 | and 10% | | |
| Volume ratio CO₂/WPI | 50:50, | No impact | No impact | No impact |
| solution | 72.5:27.5 | | | |
| | and 95:5 | | | |

### Example 2: Production of Whey Protein Aggregates—Effect of Pressure

Further trials were made with varied pressures (8, 34 and 60 MPa). The temperature (85° C.), stirrer speed (vₛₜ=3.000 rpm), ratio WPI solution:scCO₂ (95:5), WPI_{conc.} (4%), initial pH=6.44 and time (5 minutes) were not varied. The small CO₂ volume was chosen to minimise change of pH by acidity of the CO₂ gas.

TABLE 2
Applying different pressure

| | | | | | Size of whey protein aggregates | | Protein composition | | | |
|---|---|---|---|---|---|---|---|---|---|---|
| | Variables | | | | Hydrodynamic | | insoluble | native | Soluble | pH |
| | Pressure | Ratio | WPI conc. | Time | diameter | | aggregates | protein | aggregates | After |
| Trial - No. | [MPa] | WPI/CO2 | [%] | [min] | [nm] | PDI | [%] | [%] | [%] | treatment |
| VCT011112 | 60 | 95:5 | 4 | 5 | 1334 +/− 250 | 0.181 +/− 0.06 | 73.2 +/− 0.4 | 25.9 +/− 0.5 | 0.9 +/− 0.6 | 5.86 +/− 0.02 |
| VCT021112 | | | | | | | | | | |
| VCT031112 | | | | | | | | | | |
| VCT041112 | 34 | 95:5 | 4 | 5 | 1180 +/− 83 | 0.206 +/− 0.03 | 77.5 +/− 0.2 | 21.3 +/− 0.2 | 1.1 +/− 0.2 | 5.85 +/− 0.02 |
| VCT051112 | | | | | | | | | | |
| VCT061112 | | | | | | | | | | |
| VCT071112 | 8 | 95:5 | 4 | 5 | 1924 +/− 227 | 0.383 +/− 0.07 | 81.4 +/− 0.8 | 16.6 +/− 0.4 | 2.0 +/− 1.2 | 5.93 +/− 0.03 |
| VCT081112 | | | | | | | | | | |
| VCT091112 | | | | | | | | | | |

The particle size values of samples in Table 2 show that using higher pressures results in a reduction of particle size. Applying 34 MPa or 60 MPa gave no difference in particle size, but the particle sizes obtained at these pressures were significantly smaller than for trials at 8 MPa. Analyses of protein composition indicated an increased transformation of native protein into insoluble aggregates at lower pressure.

An additional comparative example VCT100312 was performed using CO₂ at a pressure of 1 MPa (i.e. not in the supercritical state):

TABLE 3

| | | | | | z-average of | | | | |
|---|---|---|---|---|---|---|---|---|---|
| | | | WPI | | Hydrodynamic | | insoluble | native | soluble |
| | Pressure | Ratio | conc. | Time | diameter | | aggregates | protein | aggregates |
| Trial - No. | [MPa] | WPI/CO2 | [%] | [min] | [nm] | PDI | [%] | [%] | [%] |
| VCT080312 | 60 | 50:50 | 7 | 12 | 2198 +/− 98 | 0.280 +/− 0.095 | 84.4 +/− 0.6 | 15.1 +/− 0.4 | 0.5 +/− 0.2 |
| VCT100312 | 1 | 50:50 | 7 | 12 | 6924 +/− 2440 | 0.568 +/− 0.110 | 88.5 +/− 0.3 | 10.8 +/− 3.4 | 0.8 +/− 3.1 |

It can be seen that the aggregates formed at this lower pressure were very different, having a much larger and more variable size. The large size makes the aggregates less stable in suspension.

### Example 3: Production of Whey Protein Aggregates—Effect of Ethanol

Depending on pressure, a maximum 5% of CO₂ is dissolvable in water [Wiebe R et al., 3.0 J. Am. Chem. Soc., 63 (2), 475-477 (1941)] and the residual CO₂ must be dispersed in WPI solution as droplets by agitation. 10% ethanol was added to the WPI solution to decrease interfacial tension between water and CO₂, resulting in smaller scCO₂ droplets in WPI solution during treatment. Two WPI concentrations of 4 wt. % and 7 wt. % and different pressures were tested. Time and volume ratio of WPI solution to CO₂ were also changed to confirm that these parameters were not influencing results compared to samples without 10% ethanol. Temperature (85° C.) and agitation were kept constant at maximum speed.

| | |
|---|---|
| Volume ratio WPI/CO₂ | 2 levels: 50:50, 95:5 |
| WPI concentration [wt. %] | 2 levels: 4, 7 |
| Time [min] | 3 levels: 5, 10, 15 |
| Pressure [MPa] | 3 levels: 9.5, 42, 60 |

The trends observed in this experimental design are reported in Table 4. The distribution of particle size (poly dispersity) was reduced by the addition of ethanol, with PDI values smallest for samples treated at 60 MPa. At higher pressures yield of insoluble aggregates increased to 85-90%. The buffering capacity of a 7 wt. % WPI solution appeared higher and that pH is probably lower in a 4 wt. % concentrated WPI solution during treatment. The duration of trial also had an impact with aggregate size increasing between 5 and 10 minutes but values are stable when time is extended. Samples treated at 42 MPa and 60 MPa were similar but aggregate size increases at lower pressure.

TABLE 4
Result trends when 10% ethanol added to the WPI solution.

| | | | | Impact on amount |
|---|---|---|---|---|
| | | | Impact on | of insoluable |
| Parameters | | Impact on size | PDI | WP aggregates |
| Pressure [MPa] | 9.5, 42 | Aggregates significantly | PDI not | Lower pressure |
| | and 60 | smaller at 42 and 60 MPa | influenced by | produces more insoluble |
| | | | pressure | aggregates |
| Treatment time [min] | 5, 10 | Particles significantly | PDI < 0.2 at 5 and | Significantly higher at 10 |
| | and 15 | smaller at 5 min | 10 min. | and 15 minutes |
| WPI concentration [%] | 4 and 7 | Particles significantly | No impact | Significantly higher at |
| | | smaller at 7% | | 7% |
| Volume ratio WPI | 50:50 | Smaller at 95:5 | Smaller at 95:5 | Significantly higher at |
| solution/CO₂ | and | | | 95:5 |
| | 95:5 | | | |
| Ethanol [%] | 10% | No impact | Significant | No impact |
| | | | reduction | |

### Example 4: Microscopy

Cryo scanning electron microscope, FEI Quanta 200F (FEI, USA), images were made of the frozen surface of whey protein aggregates to evaluate their appearance. Treated samples are prepared for SEM by depositing a drop on a cryo-holder, perforated and cooled on carbonic ice. This aliquot is then transferred into liquid nitrogen. After plunging in nitrogen slush, samples were transferred under vacuum into a pre-chamber at approx. −160° C. using a Gatan ALT02500 Cryo-System (Gatan, France). The pre-chamber is held under vacuum, approx. at 3-4×10⁻⁶ torr. In the next step the sample is freeze fractured by striking it with a razor blade to reveal its internal structure. The sample is slightly etched to −95° C. for 10 minutes in order to reveal surface details not caused by the carbonic ice itself. Samples are cooled down to −125° C. and coated with Pt—Au (5 nm) using argon plasma. Samples were transferred to the microscope chamber. Visualization of samples was carried out at a temperature of −125° C. in a Quanta 200 FEG (FEI Company, Netherlands) operated at 8 kv in HighVac mode at 3-4×10⁻⁷ torr.

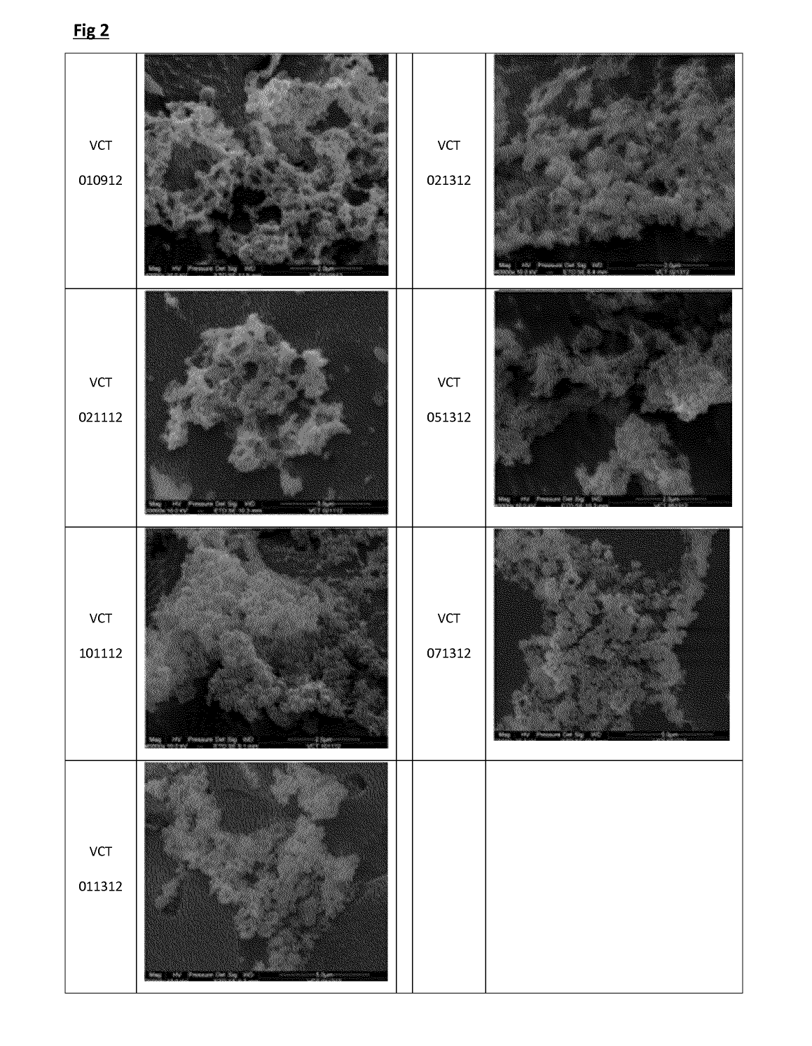

SEM micrographs of the following samples are shown in FIG. 2.

| | | Tem- | | | | | |
|---|---|---|---|---|---|---|---|
| | Pres- | per- | | | Ini- | WPI | |
| | sure | ature | Time | Ratio | tial | conc. | Eth- |
| Trial - No. | [MPa] | [° C.] | [min] | WPI:CO₂ | pH | [%] | anol |
| VCT010912 | 8.5 | 85 | 5 | 95:5 | 6.46 | 4 | — |
| VCT021112 | 59 | 85 | 5 | 95:5 | 6.44 | 4 | — |
| VCT101112 | 58 | 85 | 5 | 95:5 | 6.44 | 4 | 10% |
| VCT011312 | 60 | 85 | 15 | 50:50 | 6.44 | 4 | 10% |
| VCT021312 | 60 | 85 | 15 | 95:5 | 6.44 | 4 | 10% |
| VCT051312 | 60 | 85 | 15 | 95:5 | 6.45 | 7 | 10% |
| VCT071312 | 60 | 85 | 5 | 95:5 | 6.45 | 7 | 10% |

The micrographs show that single aggregates are spherical but the small single aggregates appear linked, resulting in larger structures exhibiting a sponge-like appearance.

### Example 6: Comparative Example Showing Treatment without Addition of Carbon Dioxide

To evaluate the effect of treatment without the addition of CO₂, an aqueous WPI solution with 10% ethanol was adjusted to its isoelectric point at pH 5.2. Treatment parameters were set to the condition of VCT011312 (fourth line of table above). A SEM micrograph of the aggregates produced at the isoelectric point but without supercritical CO₂ (FIG. 3) shows spherical aggregates which are linked to larger agglomerates but without the sponge-like structures observed for the aggregates produced by the process of the invention. The aggregates are in the form of chains.

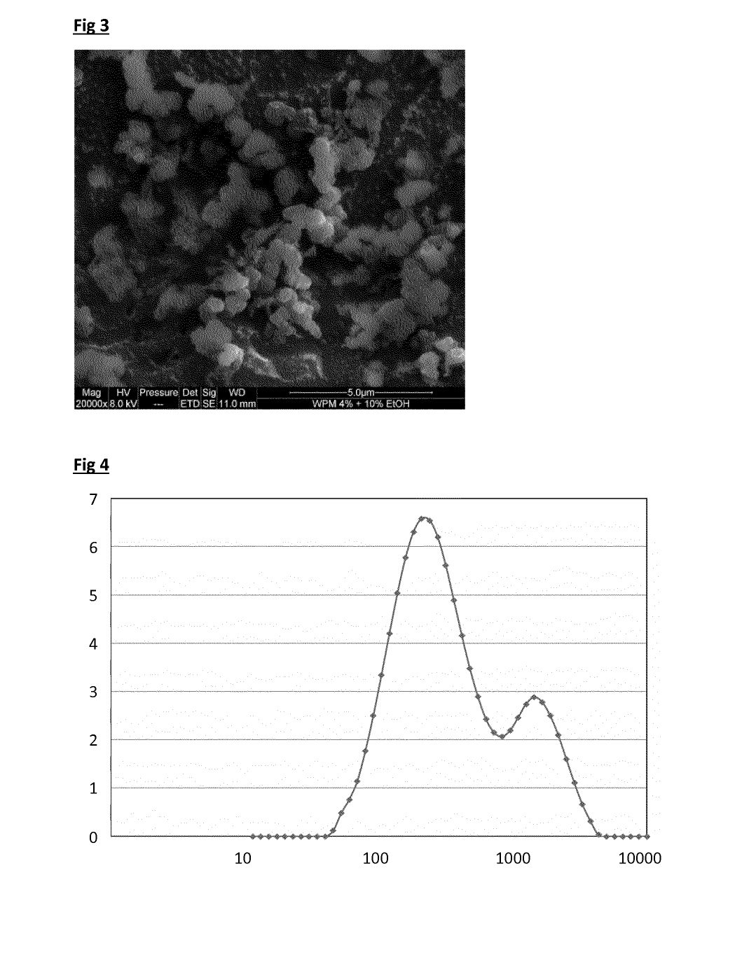

The particle size distributions of sample VCT011312 (FIG. 4) and the aggregates produced at the isoelectric point but without addition of supercritical CO₂ (FIG. 5) were determined with a Mastersizer 2000 instrument (Malvern Instruments Ltd., USA). The Mastersizer provides more exact size distribution information than the Nanosizer, especially for larger particles. Deionised water was used as dispersant with a refractive index of 1.33, the WPM dispersion was set at 1.36. Particle size diameter is expressed as volume percentage D[v,x], and the calculation refers to [ISO 9276-2:2001]. The median value D[v,50] of the particle size distribution divides the particle population exactly into two equal halves, concluding there is 50% of the distribution above this value and 50% below. VCT011312 had a D[v,50] of 0.27 μm whereas the sample without addition of CO₂ but otherwise under the same conditions had a much larger D[v,50] of 2.63 μm. Treatment with supercritical carbon dioxide thus can be seen to strongly reduce the particle size, which is confirmed by comparing the particle size distributions plotted in FIGS. 4 (VCT011312) and 5 (no CO₂). The large volume of aggregates in a size range of 50-400 μm for the comparative example not treated with CO₂ will lead to spontaneous precipitation in solution.

### Example 7: Interfacial Tension Air/Whey Protein Aggregate Solution

The whey protein aggregates formed by the process of the invention were found to act as surfactants, able to create a stable foam or emulsion. Interfacial tension was measured to evaluate the interfacial properties of the created whey protein aggregates. A pendant drop tensiometer (Tracker, Teclis, France) was used to measure the interfacial tension according to the axisymmetric drop shape analysis.

Chosen dispersion concentrations were 0.04 wt % and 0.004 wt % whey protein aggregates samples VCT011312 and VCT021312. All measurements were performed at room temperature. The capillary used for the analysis had an inner diameter of 0.8 mm, and an air bubble or oil droplet was produced statically inside 6.5 ml of solution. For measurement, liquid density was needed, and this was measured using a Densimeter DMA 4500 (Anton Paar, Switzerland). Measurement time of minimum 30 minutes was needed to obtain constant values.

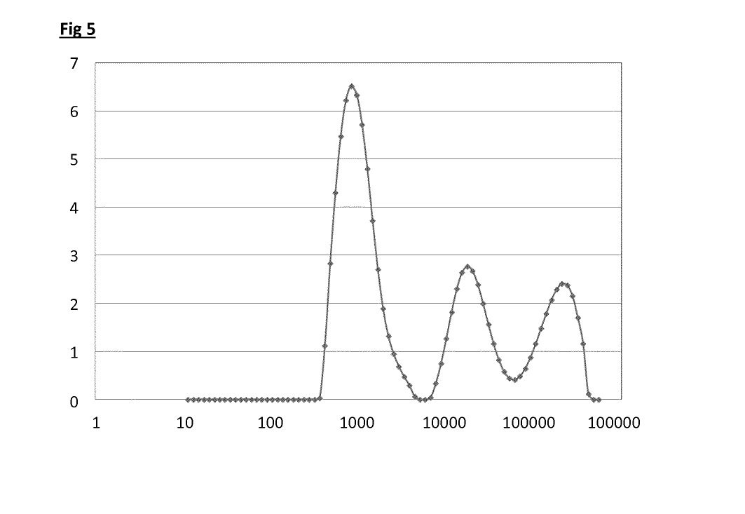

FIG. 6 shows the interfacial tension between air and whey protein aggregate solutions at a concentration of 0.004%. The reference is water plus 0.001% ethanol. FIG. 7 shows the interfacial tension between air and whey protein aggregate solutions at a concentration of 0.04%. The reference is water plus 0.01% ethanol. While the interfacial tension of water/ethanol and an air bubble is at about 72 mN/m, interfacial tension with the whey protein aggregates according to the process of the invention was reduced by 10 to 20 mN/m depending on whey protein aggregate concentration.

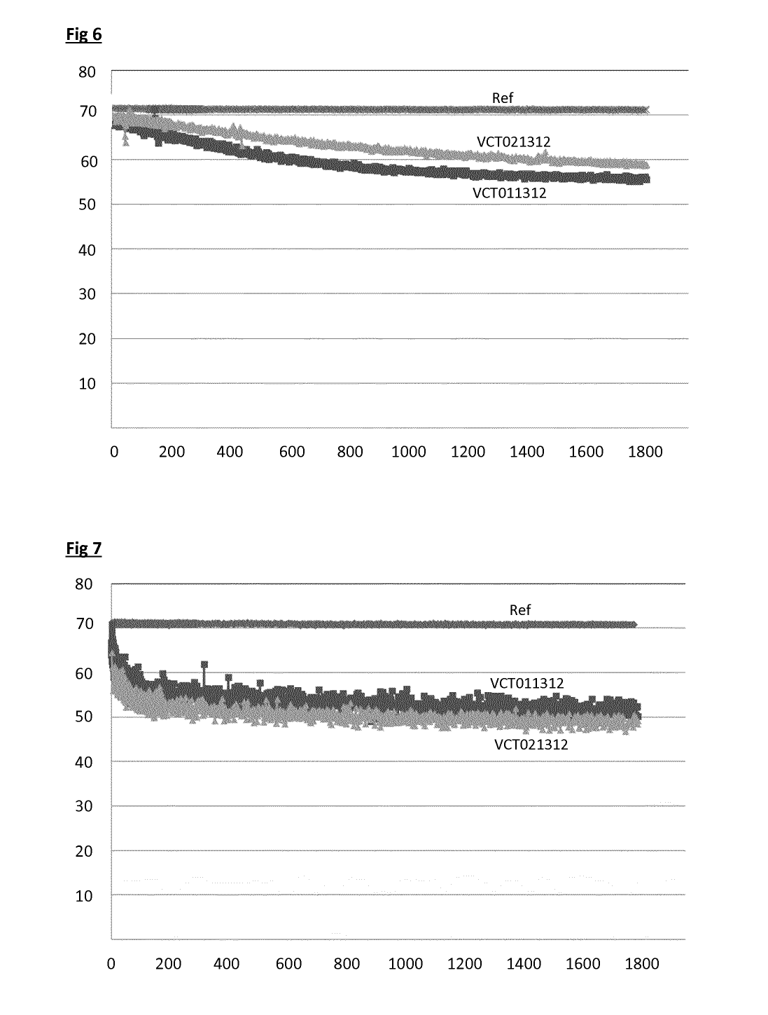

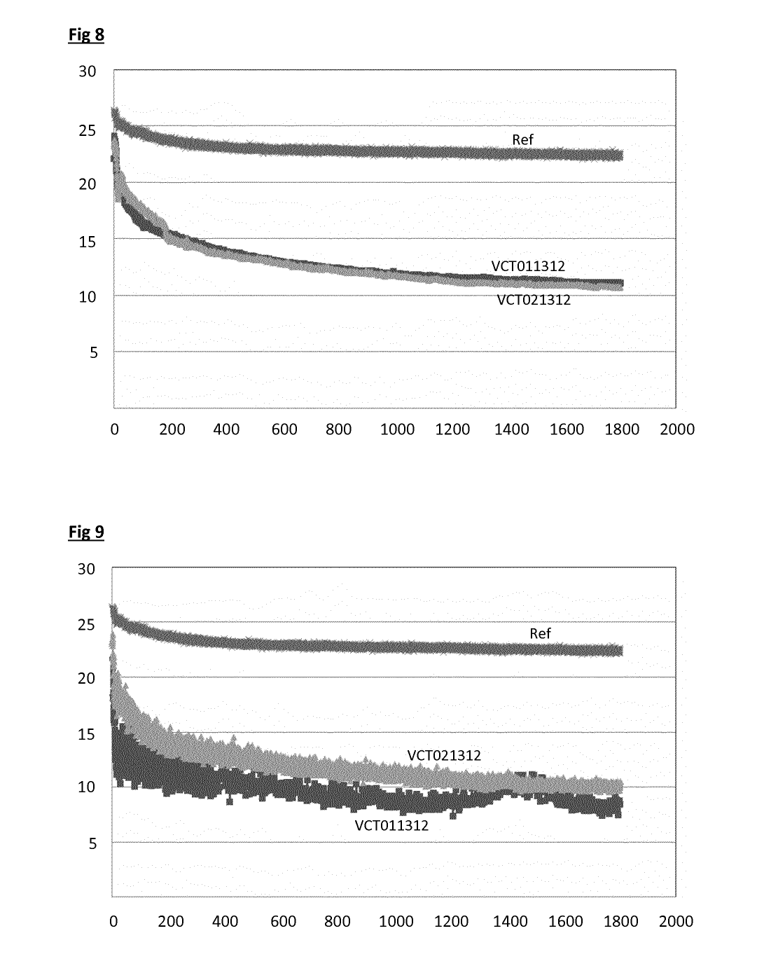

FIG. 8 shows the interfacial tension between oil and whey protein aggregate solution at a concentration of 0.004%. The reference is an oil droplet in pure water/ethanol. FIG. 9 shows the interfacial tension between oil and whey protein aggregate solutions at a concentration of 0.04%. The reference is an oil droplet in pure water/ethanol. The interfacial tension is reduced by more than 50% compared to an oil droplet in pure water/ethanol, leading to a final value of 10 to 12 mN/m. This demonstrates the good emulsification properties of whey protein aggregates formed by the process of the invention.

1. Process for forming whey protein aggregates, the process comprising:
heating an aqueous solution of native whey protein to a temperature above 80° C.;
dissolving carbon dioxide in the whey protein solution at a pressure greater than 7.39 MPa absolute, and;
releasing the pressure to a level below 0.2 MPa absolute.

2. A process according to claim 1 wherein ethanol is in the approved solution at a level of between 5 and 20 wt. % of the solution.

3. A process according to claim 1 wherein the pressure is released by passing the whey protein solution with dissolved carbon dioxide through a nozzle and evaporating water so as to form a powder comprising whey protein aggregates.

4. A process according to claim 1 wherein the native whey protein is present in solution at a concentration of between 0.5 wt. % and 40 wt. %.

5. A process according to claim 1 wherein the volume ratio of native whey protein solution to carbon dioxide is between 1:99 and 99:1 under the operating conditions.

6. A process according to claim 1 wherein the whey protein solution with dissolved carbon dioxide is maintained at a pressure greater than 7.39 MPa for at least 1 minute.

7. A process according to claim 1 wherein the native whey aqueous solution has an initial pH between 6.2 and 9.0.

8. A process according to claim 1 wherein the native whey protein contains less than 2.5 wt. % divalent cations.

9. A process according to claim 1 wherein the whey protein solution with dissolved carbon dioxide comprises bacteria inactivation agents.

10. A process according to claim 1 comprising:
heating the native whey protein solution at a temperature of between 80° C. and 95° C.;
dissolving the carbon dioxide in the whey protein solution at a pressure between 50 and 70 MPa absolute and maintaining this pressure for between 2 and 20 minutes, and;
releasing the pressure to a level below 0.2 MPa absolute;
wherein the native whey protein is present in solution at a concentration of between 10 wt. % and 20 wt. %.

11. Composition comprising whey protein aggregates obtainable by the process of claim 1.

12. A composition according to claim 11 wherein the composition is in a form selected from the group consisting of a food composition, cosmetic composition and pharmaceutical composition.

13. A composition according to claim 12 wherein the food composition is in a form selected from the group consisting of a nutritional composition, dairy product, ice cream, sauce, pet food and confectionery product.

14. A composition according to claim 12 wherein the food composition is a concentrated whey protein drink.

15. (canceled)
